(19) United States
(12) Patent Application Publication
(10) Pub. No.: US 2017/0352114 A1
(43) Pub. Date: Dec. 7, 2017

(54) APPARATUS FOR PROVIDING TRAVELING INFORMATION AND METHOD FOR PROVIDING TRAVELING INFORMATION USING A TRAVELING IQ TEST

(71) Applicant: Jongjin KIM, Gyeongsangnam-do (KR)

(72) Inventor: Jongjin KIM, Gyeongsangnam-do (KR)

(21) Appl. No.: 15/175,415

(22) Filed: Jun. 7, 2016

(51) Int. Cl. G06Q 50/14; G09B 7/00; G06Q 50/12

(52) U.S. Cl. CPC G06Q 50/14; G06Q 50/12; G09B 7/00

(57) ABSTRACT

An apparatus for providing travel information and a method thereof are provided. The apparatus is: a main server, where a storage unit that stores a plurality of data information spots and restaurants information data area of the travel of the travel area; a travel information storage unit to the sights and restaurants of the local travel information for regional travel processed quiz data storage; a character storage unit for storing at least one quiz submitter character data; a travel IQ for Running the test at the user terminal; a travel IQ score calculation unit for calculating a score by comparing the answer data which is input through the user terminal and the correct answer of the quiz data; and a traveler rating based on the travel IQ scores and the travel IQ scores are calculated by the score calculating unit trip.

### BACKGROUND OF THE INVENTION

### Field of the Invention

The invented apparatus for providing traveling information and method for providing traveling information such as traveling attractions, famous restaurants in a quiz format and provide traveling IQ score to provide excitement.

### Description of Related Art

In general, the information gathered about the trip is to gather relevant information through the majority of tourist travel magazines or on the Internet and travelers make destination choice based on the collected information.

Not only the specific information on the destination has cumbersome problems in information gathering and time consumption for beginner travellers, the collected information do not contain sufficient information such as the destinations, attractions, accommodation, recreational facilities, food establishments.

Meanwhile, in the case of travellers who travel frequently around the region or for the locals, most of the sights and experiences to the restaurants have been experienced so there is no difficulty or hassle of gathering travel information. But there is down side of decreased travel interest.

Prior art document: (Patent Document 1) Republic of Korea Laid-Open Patent Publication No. 10-2011-0011286 (2011 Feb. 8).

### SUMMARY OF THE INVENTION

This invention is to solve the problem of the above; the travel area is rather difficult and collection of information about the destination for the first travellers. The collation of information not only saves a frustrating journey but also improves on the time-consuming especially for the traveller of the country, or travelers whom are familiar with the location or residents who live in the area.

Therefore the invented apparatus for providing traveling information and method for providing traveling information such as traveling attractions, famous restaurants in a quiz format and provide traveling IQ score to provide excitement.

In addition, the present invention is provided by dividing the traveler ratings depending on travel IQ scores create a customized travel with your travel IQ test that can be convenient and provide efficient informative travel information to all travelers that travel with local device and to provide travel information delivery method it aims.

In addition, the present invention is provided with a quiz submitter and by providing travel information with your travel IQ test can improve your concentration by progress in an interactive way to give answers to questions between the user and device.

Further, the purpose of this invention is to store the travel with a quiz by explanatory text, video content, to the question of modular data processed and IQ quiz makers can be so manufactured as to be supplied.

This invention is trying to address projects that are mentioned here, and not limited to tasks referred to in more than not this invention has been wanted to solve other tasks. The entry of this invention from below, for persons who had knowledge of trade in technical fields to which can be clearly understood.

To solve the problem: Travel information providing apparatus according to the invention, provided on the main server, where storage unit that stores data information spots and restaurants information data area of the travel of the travel area; provided on the main server, trivia information storage unit to the sights and restaurants of the local travel information for regional travel processed quiz data storage; to submit the data to the interactive quiz, the character storage unit for storing at least one quiz submitter character data; running the travel IQ test at the user terminal, but from a plurality of quiz data by randomly extracting the quiz data from the predetermined number from the quiz storage unit provided on the user terminal, receiving the quiz submitter character data from a character storage unit quiz submitter character submit the quiz and submit quiz answers provided interactively to enter data via a user terminal unit; travel IQ score calculation unit for calculating a score by comparing the answer data which is input through the user terminal and the correct answer of the quiz data; Traveler rating based on your travel IQ travel IQ scores and IQ scores calculated by the score calculating unit trip includes travel IQ display unit that displays on the user's terminal.

In addition, the image contents is characterized in the storage of the quiz data, comment block, quizzes block and tourism regions showing the attractions information or restaurants information on travel regions quiz tour the area represented by the spot information or comment for restaurants Information of the tour area travel area of the present invention is processed into the form of a quiz module restaurants information or travel information of the spot area including an image representing the content block.

In addition, travel information providing apparatus of the present invention is provided on the main server, further comprising traveling course data linking attractions or restaurants in the travel area with a journey Course Save to save the travel area map data, quizzes, submit blowing revenge by extraction quiz data for the attractions or restaurants located on the travel course of the tour course data from the quiz data from the quiz storage unit, by linking to a map data, while along the travel course on the map to move in order to end points from the starting point.

In addition, the traveling course storage unit of the present invention can be characterized as it separates the travel course data stored in accordance with the purpose of the trip attraction tours or gourmet tours. It stores a plurality of traveling course data but for walking tour, bus tour or rental car tour are separately stored in accordance with the purpose of the trip.

In addition, travel information providing apparatus of the present invention is characterized with a base selection of the combination of the restaurants information data of the spot data and travel area of the trip region in accordance with the rating, including a providing travel information to provide personalized travel information on the user terminal further to the storage unit attractions data and travel. You can save your travel preferences information based on traveler ratings to each of the restaurants information data area, and attractions information, data and trip travel area with tourist information providing unit travel preference information of the tour area selection information for restaurants in the area.

In addition, travel information providing apparatus of the present invention is the travel course change unit in the travel information provided to the user terminal and attractions information, deleting data and gourmet information data of the travel area or additional travel area displays the travel course change; Produced by the ingestion Itinerary changes are proposed to the traveling course data, the course proposed trips unit for transmitting data suggest the Itinerary parts store; Are placed on a main server, via the user terminal receives the user's age information, user gender, user revisit whether or at least one or more of the user of the vehicle whether or not the information, collecting the user information unit for collecting user information. It is placed on a main server, IQ trip travel IQ test result collecting unit which collects travel IQ test result information from the score calculating unit. It is placed on a main server, real-time review the collecting part that collects real-time review information received from the user terminal in the course of the tour restaurants and attractions of the travel area of the travel area; And user information, travel IQ test results information and by linking real-time review information, travel preferences information, travel marketing information or travel policy to be created to determine information about the user information, travel IQ test results, information and aggregate real-time review information to travel Vic and a further comprising; big trip data storage unit for storing data in the form.

In addition, travel information providing apparatus of the present invention is the video content storage unit that is provided on the main server, storing the image data produced in connection with the quiz content data; your images through a user terminal by taking a picture of one of the restaurants located in the area of travel sites and travel to the region to create your video content, data content producer; and is provided on the main server, a user image content receiving data stores, and other user terminals with real-time sharing, or the user image content storage unit to provide the submitting quiz portion; further comprising a user image content storage unit, user terminal or other real-time and the review information inputted through the user terminal characterized in that the store associated with the user to the video content data.

The travel information providing method according to the invention includes the first step that stores information data of the spot information data and restaurants around the travel area on the main server; the second stage by processing the information of the restaurants and attractions of the tour information local travel area with the data stored on the main server quiz form; to submit the data to the interactive quiz, a third step of storing at least one quiz submitter character data on the main server; running the travel IQ test at the user terminal, submitted but extracts randomly quiz data of a predetermined number among the plurality of quiz data provided on a user terminal, receiving the quiz submitter character data from a character storage unit quizzes submitter character quiz and a fourth step of providing a conversation by entering the answer data from the user terminal; a fifth step of calculating a score by comparing the answer data which is input through the user terminal and the correct answer of the quiz data; a traveler in accordance with the rated travel IQ scores and travel IQ score calculated from the fifth step a sixth step of displaying on the user terminal; and traveler information data by selecting and combining the restaurants of the area attractions and travel information data area of travel, depending on grade, seventh step of providing personalized travel information to the user terminal.

Effects of the Invention: By solving the above problems, the method provides effect for travel information. It providing the equipment and travel information using IQ tests. The present invention submits attractions and restaurant information on travel regions in a quiz form and informs your travel IQ score lead to give travel interests.

In addition, the method provides the travel information providing equipment with travel information using IQ tests. The present invention is divides the traveler ratings depending on travel IQ scores and provide simple travel informative to all travelers that travel the area by creating a personalized travel information and there is an effect that can be provided efficiently.

In addition, the travel information providing device and travel information provision method using a travel IQ testing of the invention is provided effectively with a quiz submitter character progression in an interactive way of answer to give questions between quiz submitters and users can improve your concentration.

Further, IQ test trip travel information providing apparatus and method using a travel information service of the present invention, by making the quizzes description data, video content, modularized into question by processing and storage, there is an effect that the quiz producers can be manufactured easily.

### BRIEF DESCRIPTION OF THE DRAWINGS

FIG. 1 is a schematic view showing a first main server and a user terminal that provides travel information device is configured according to an embodiment of the present invention.

FIG. 2 is a block diagram showing a travel information providing apparatus according to the first embodiment of the present invention.

FIG. 3 is a view showing a travel location which is stored in storage Where a storage unit of the providing travel information device according to a first embodiment of the present invention.

FIG. 4 is a view showing a start screen of the travel IQ test according to the first embodiment of the present invention.

FIG. 5 is a view showing a travel IQ test screen that is running in the quiz submission of operations according to the first embodiment of the present invention.

FIG. 6 is a view showing the IQ scores and tourist travel rates represented by the operation of the travel IQ display according to the first embodiment of the present invention.

FIG. 7 is a view showing the travel information provided to the travel information provided of operations of the first embodiment of the present invention.

FIG. 8 is a block diagram showing a travel information providing apparatus according to the second embodiment of the present invention.

FIG. 9 is a view showing a discount ticket sales screen displayed in the operation of the discount ticket sales department according to the second embodiment of the present invention.

FIG. 10 is a block diagram showing a travel information providing apparatus according to the third embodiment of the present invention.

FIG. 11 is a block diagram showing a travel information providing apparatus according to a fourth embodiment of the present invention.

FIG. 12 is a view showing a travel IQ test screen according to a fourth embodiment of the present invention.

FIG. 13 is a block diagram showing a travel information providing apparatus according to a fifth embodiment of the present invention.

FIG. 14 is a view showing a travel IQ test screen that is running in the quiz submission of operations according to the fifth embodiment of the present invention.

FIG. 15 is a diagram showing another screen of a travel IQ test running as quiz submission of operations according to the fifth embodiment of the present invention.

FIG. 16 is a block diagram showing a travel information providing apparatus according to a sixth embodiment of the present invention.

FIG. 17 is a view showing a travel IQ test screen that is running in the quiz submission of operations according to the sixth embodiment of the present invention.

FIG. 18 is a view showing for explaining another example of service travel information device according to a sixth embodiment of the present invention.

FIG. 19 shows a graph preference information utilizing travel big data are implemented by providing travel information device according to still another embodiment of the present invention.

FIG. 20 is a flow chart illustrating a travel information providing method according to an embodiment of the present invention.

### DETAILED DESCRIPTION OF THE PREFERRED EMBODIMENTS

The problem to be solved of the present invention as described above, the specific details, including the solution, the effect of the invention of the assignment are included in the embodiments to be described in the following examples and drawings. Advantages and features and methods of accomplishing the same of the present invention by reference to the embodiments which are described in detail in conjunction with the accompanying drawings will be apparent.

With reference to the accompanying drawings, it will be described the present invention in more detail.

### First Embodiment

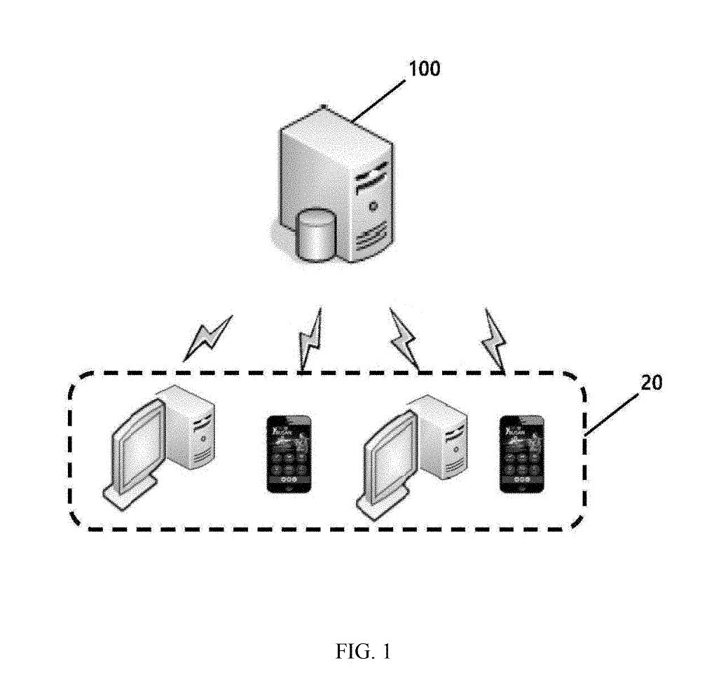

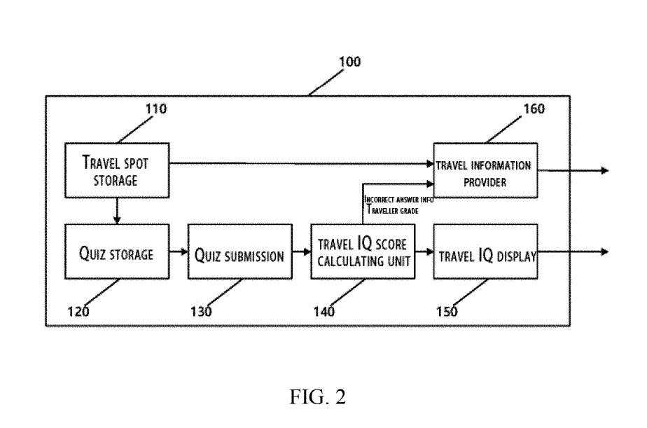

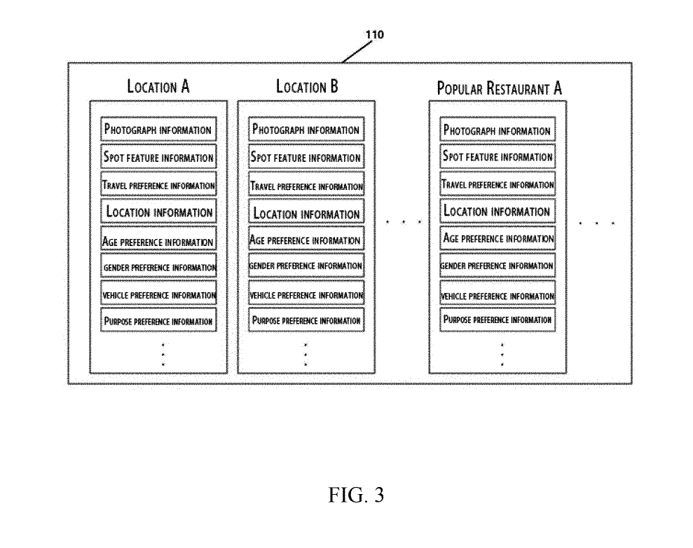

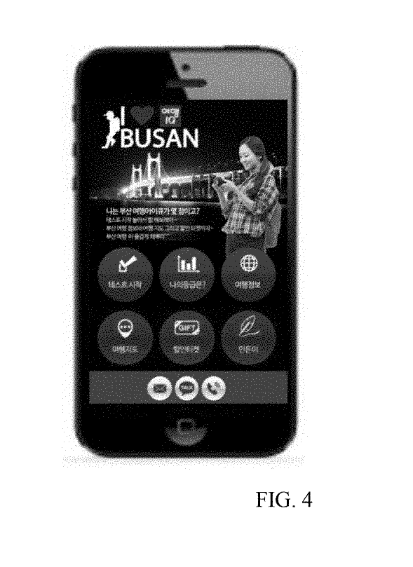

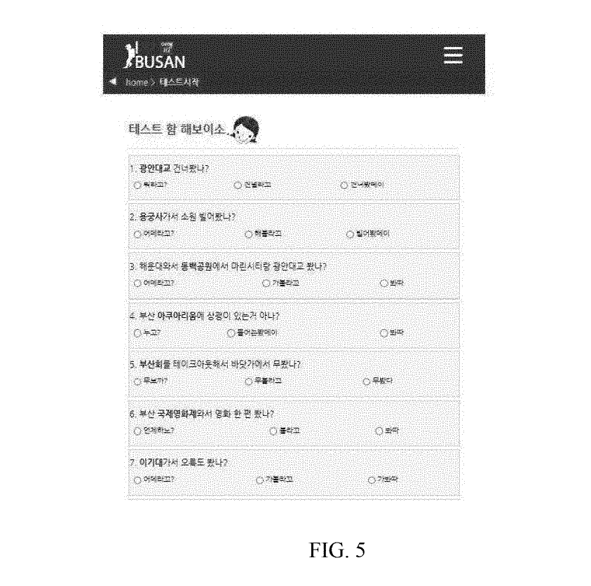

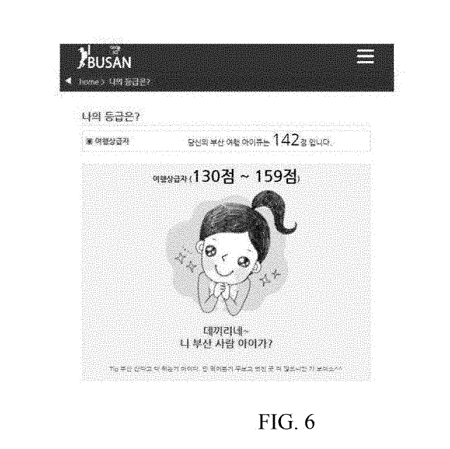

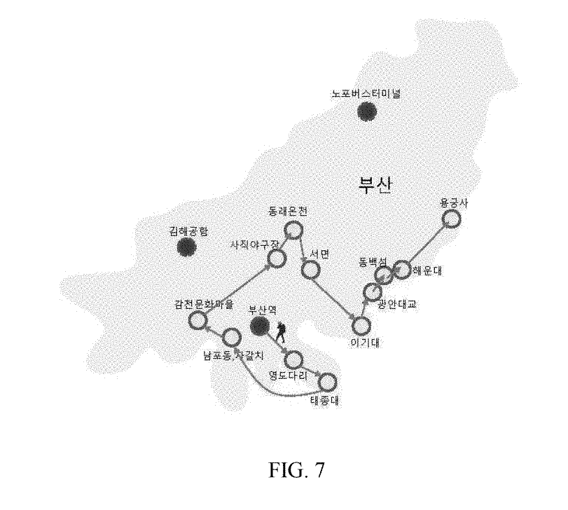

FIG. 1 to FIG. 7 is a diagram for explaining a travel information providing apparatus according to the first embodiment of the present invention. Specifically, FIG. 1 is a schematic diagram showing a main server and a user terminal that is travel information providing device is configured according to the first embodiment of the present invention, FIG. 2 is a view of the travel information providing apparatus according to the first embodiment of the present invention block diagram, and FIG. 3 is a view showing a travel location storage to be stored in. Where a storage unit of the providing travel information according to the first embodiment of the device of the present invention, FIG. 4 is traveling in accordance with a first embodiment of the invention IQ a view showing a start screen of the test, FIG. 5 is a view showing a travel IQ test screen that is running in the quiz submission of operations according to the first embodiment of the present invention, FIG. 6 is according to the first embodiment of the present invention travel a view showing the IQ scores and tourist travel rates represented by the operation of the display unit IQ, FIG. 7 is a view showing the travel information provided to the travel information provided of operations of the first embodiment of the present invention.

As illustrated in FIG. 1 to FIG. 7, the first providing travel information according to the embodiment device of the present invention, Where the storage unit 110, a quiz storage unit 120, quiz submitting unit 130, a travel IQ and a score calculating unit 140 and the IQ trip display unit 150.

Where the storage unit 110 is provided on the main server 100, and stores the data and information spots restaurants information data area of the travel of the travel area. Referring to FIG. 3, are stored as other information, a single spot information data, picture information, feature information spots are data. For example, if Haeundae is A spot: photos, features, travelers grades opinion of Haeundae Beach in Busan Haeundae, Haeundae location, age-specific Haeundae preference score, Haeundae preference scores by gender, Haeundae preference score of the vehicle or absence all travel information, such as the Busan Haeundae preference scores are stored in accordance with the purpose of travel for each item.

Quiz storage unit 120 stores provided on the main server 100, by processing the information of the restaurants and attractions travel information area of the area of travel of the quiz data types.

Quiz 130 submitted, 4 and 5 when running travel IQ test from the user terminal 20, as shown, by randomly extracted from the plurality of quiz data quiz data of a predetermined number from the quiz storage unit 120. It is provided on the user terminal 20. The quiz consists relates to attractions and restaurants. Quiz submitting unit 130 by limiting the time to solve per quizzes, it is possible to prevent the problem pool through the Internet search.

Travel IQ score calculating unit 140 compares the answer data to be input through the user terminal 20 and the correct answer of the quiz data and calculates a score. At this time, the quiz appointed by the difficulty it is possible to further score additional points. Here, travel IQ the knowledge and information about attractions and restaurants, that major travel places in the area to be shown to quantify the level through a quiz solving the above, in the first half of the present invention to use the definitions referred to as travel IQ.

IQ trip display unit 150 as shown in FIG. 6, a traveler in accordance with the rated trip travel IQ scores and IQ scores calculated from a travel IQ score calculating unit 140 will be displayed on the user terminal 20.

In this way, it is possible in the first embodiment of the present invention, while traveling the IQ Test to test their knowledge level for the trip confirm the result by the number, such as IQ. For example, the Busan trip. To test their level of knowledge about Busan travel, you can check your understanding of the Busan trip with the quiz questions that are composed of a core and the destination information in that area.

Accordingly, to have a fun testing on their journey level through a travel IQ test using an IQ test method, with people traveling can cause lead to interesting and fun the other hand, it can be provided along with travel information in the process of solving the quiz.

For example, traveler rating can be give four stages of travel. They are beginners trip, intermediate trip, senior trip and professionals.

On the other hand, FIGS. 2 and 7, the travel information providing apparatus according to the first embodiment of the present invention, selection of the combination of the spot information data and restaurants information data in the travel region of the trip region in accordance with a base level, it is possible for the user to include a travel information providing unit 160 for providing a personalized travel information on the terminal 20 more.

At that time, vacation spots like FIG. 3; the local attractions with travel data and information (110) books have gone that travel trip preferences under class a local restaurants each data(160) is a travel preferences using information to store information, travel information travel information data more local restaurant information data and local attractions are chosen reliably and it can be combined.

Further, restaurants and attractions by selecting travellers to generate the information, to improve accuracy and reliability include more information with which the following leveraging is available.

First of all, the journey by that place books at (110) conducted in the first example of this invention is travel location information saved in local restaurants data and local attractions.

As a result, travel information provider 160 in association with the position of the user terminal (20), and among the restaurants data attractions information data of the selected tour the area and travel area set the path to the remote location from the local area places itinerary granulation to it is possible to provide a travel information.

In addition, where the storage unit 110 stores restaurants information data in preference according to each age with preference information based on the preference information. The vehicle preference based on gender, preferences information in accordance with the purpose of travel attractions data and travel area are stored.

Thus, travel information providing unit 160 requests the age information, gender information, vehicle presence information and traveling object information to the user terminal 20, and receives the age information, gender information, vehicle presence information and traveling object information, it is possible to reflect together when selecting restaurants and attractions data depending on the area of the travel area of travel traveler ratings.

In addition, travel information provider 160 is to send a gourmet Data from travels IQ scores received the incorrect information from the calculator 140, and incorrect travel attractions when generating information data and priority ranking is possible for selection. Incorrect responses are preferably more likely to be caused by a lack of information and knowledge of the primary destination so traveling to recommended travel destination would be wise.

Thus, the first providing travel information with your travel IQ test device according to an embodiment of the present invention, by giving the information submitted in the sights and restaurants in the area to travel quiz form and inform your travel IQ score may lead to an interesting trip.

Furthermore, the first providing travel information with your travel IQ test in accordance with an embodiment apparatus of the present invention is divided traveler ratings depending on travel IQ scores informative travel information to all travelers that travel the area by creating a personalized travel information simple and can be provided efficiently.

### Second Embodiment

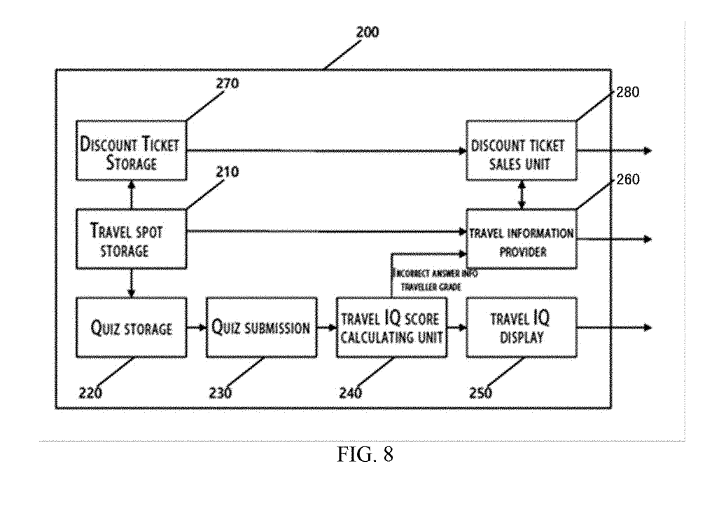

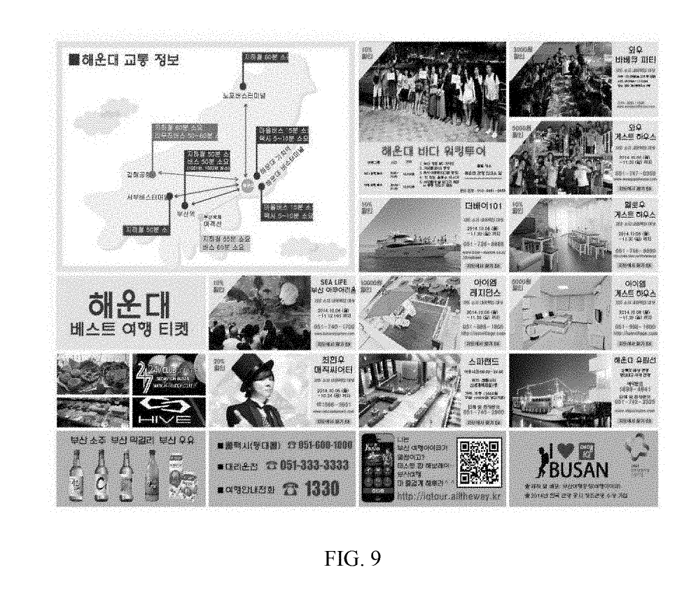

FIG. 8 and FIG. 9 are diagrams for explaining a travel information providing apparatus according to the second embodiment of the present invention. Specifically, FIG. 8 is a second block diagram showing a travel information providing apparatus according to an embodiment of the present invention, FIG. 9 is a discount ticket sales screen displayed in the operation of the discount ticket sales department according to the second embodiment of the present invention a diagram showing.

As shown in FIGS. 8 and 9, provides travel information according to the second embodiment device of the present invention, Where the storage unit 210, a quiz storage unit 220, quiz submitting unit 230, a travel IQ includes a score calculation unit 240, a travel IQ display unit 250, travel information provider 260, a discount ticket storage unit 270 Sales and discount tickets (280).

Here, the travel place the storage section of the travel information providing apparatus according to the second embodiment 210, a quiz storage unit 220, quiz submitting unit 230, a travel IQ score calculation unit 240, a travel IQ display unit of the present invention 250 and the configuration and operating characteristics of the travel information provider 260, a first embodiment travel information provided. Where the storage unit 110, a quiz storage of the device according to the part of the invention 120, a quiz part submitted 130, travel IQ score calculation unit 140, a travel IQ display unit 150, and so the configuration and operating characteristics of the travel information provider 160 and the same or similar, whereby a more detailed description is to FIGS. 1 to 7 to refer to the first embodiment of the present invention through, and hereinafter omitted.

Referring to FIGS. 8 and 9, a travel information providing apparatus according to the second embodiment of the present invention further includes a discount ticket storage unit 270 and the discount ticket sales department 280.

Discount ticket storage unit 270 is located on the main server 200, and stores the data for each discount tickets for attractions and restaurants in the travel area.

Discount Ticket Sales 280 by linking the discount ticket data to restaurants Data attractions Data and tour areas of the travel region selected from the trip information providing unit 260 and displayed on the user terminal (20), a user terminal (It sells discount tickets purchased in accordance with the request of 20).

Thus, the available travel by the traveling IQ test according to the second embodiment device of the present invention, there is an advantage capable of contributing to the local tourist industry activation and local economic development through the sale of discount tickets to integrate the travel.

### Third Embodiment

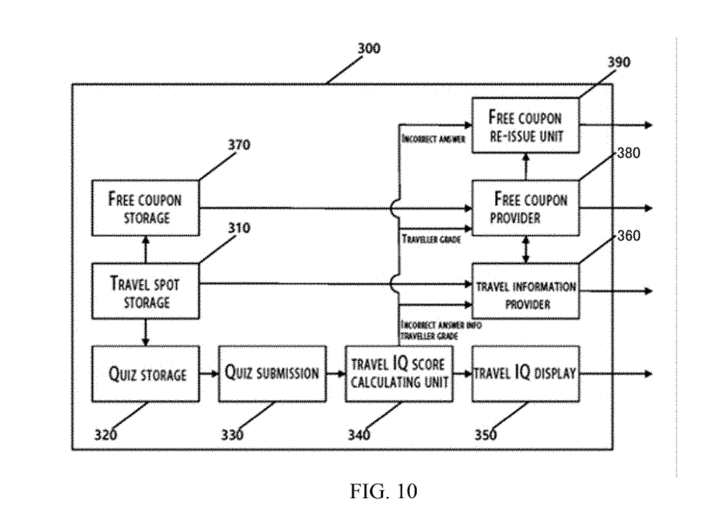

FIG. 10 is a block diagram showing a travel information providing apparatus according to the third embodiment of the present invention.

FIG. 10, the third provides travel information according to the embodiment device of the present invention, travel location storage part 310, quiz storage unit 320, a quiz submitting unit 330, a travel IQ score calculation unit (340), travel and display IQ 350, providing travel information (360), free coupons storage unit 370, providing free coupons 380, and includes a free coupon reissued section (390).

Here, travel place the storage section of the travel information providing apparatus according to the third embodiment of the present invention 310, a quiz storage unit 320, a quiz submitting unit 330, a travel IQ score calculation unit 340, a travel IQ display 350 and the configuration and operating characteristics of the travel information provider 360, a first embodiment travel information provided Where the storage unit 110, a quiz storage of the device according to the part of the invention 120, a quiz part submitted 130, travel IQ score calculation unit 140, a travel IQ display unit 150, and so the configuration and operating characteristics of the travel information provider 160 and the same or similar, whereby a more detailed description is to FIGS. 1 to 7 to refer to the first embodiment of the present invention through, and hereinafter omitted.

The travel information providing apparatus according to the third embodiment of the present invention further includes a free coupon storage unit 370, providing free coupons 380, and free coupons reissue unit 390.

Free coupons storage unit 370 is provided on the main server 300, and stores the data for the free coupons for attractions and restaurants each trip travel regional areas.

The free vouchers providing 380 free vouchers by linking data on restaurants and travel information data, information data of attractions in the local area to be selected to travel in the travel information provider 360 displayed on the user terminal 20. In addition, free coupons providing unit 380, but provide a free coupon at the request of the user terminal 20, and, unlike the number of free coupons provided according to the tourist class. For example, the travel experts will offer four free coupons, and travel supervisor is offering three free coupons travel intermediates two free offer coupons, travel beginners by providing one free coupons, travel IQ test and solving the problem of increasing the concentration, it can inspire more interest and attention.

Free coupons reissue unit 390 receives incorrect information from a travel IQ score calculation unit 340, but provides an incorrect answer, a free coupon of restaurants in the sights and travel area of the travel area, the travel user terminal 20 incorrectly determine whether the location of the tour area attractions and restaurants in the area, and if you provide an incorrect answer in the quiz data back to the user terminal 20 it guesses the right answer, to re-issue free coupons for the place. In other words, to reissue free coupons to reissue unit 390, the coupons for incorrect travel places can be induced to move the user to an appropriate place and can further enhance the effect of inducing an interesting journey.

Thus, the third service information using a travel trip IQ test according to an embodiment the apparatus of the present invention can contribute to the local tourist industry and enable the economic development area through the provision of a free coupon for the trip interlock information.

### Fourth Embodiment

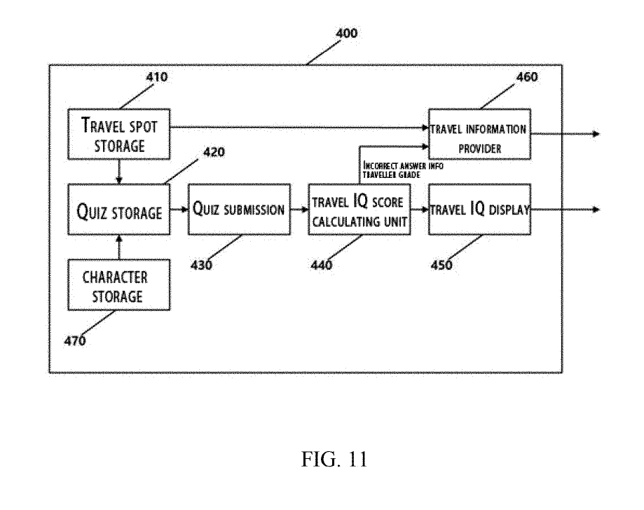

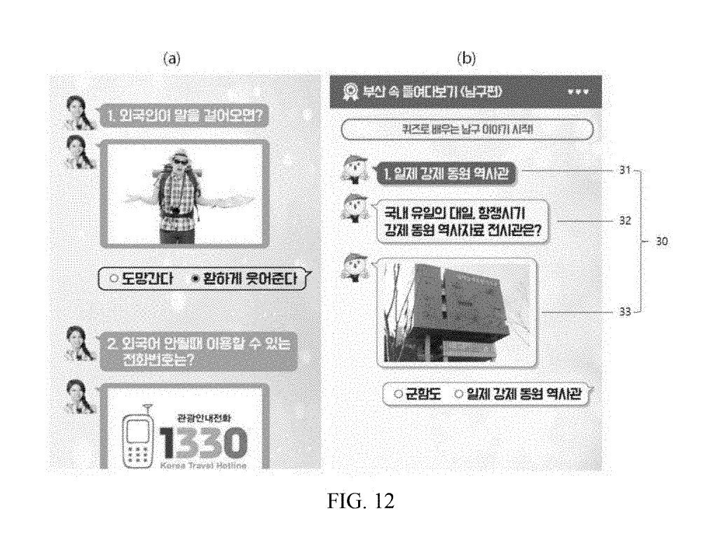

FIG. 11 and FIG. 12 are diagrams for explaining a travel information providing apparatus according to the fourth embodiment of the present invention. Specifically, FIG. 11 is a fourth block diagram showing a travel information providing apparatus according to an embodiment of the present invention, FIG. 12 is a view showing a travel IQ test screen according to a fourth embodiment of the present invention.

As are shown in FIGS. 11 and 12, a travel information providing apparatus according to the fourth embodiment of the present invention, the first embodiment Where the storage unit 410, a quiz storage portion, such as 420, of the present invention, quiz submission section 430, travel IQ score calculation unit 440 travel IQ display 450, and travel information, and includes a first study 460, at least one quiz submitter character in order to submit the quiz data into interactive data the character storage unit 470 for storing further includes.

Accordingly, quiz submitting unit 430, a storage unit for the character in order to submit the data to the interactive quiz, storing at least one quiz submitter character data; Running the travel IQ test at the user terminal, from among a plurality of quiz data by randomly extracting the quiz data from the predetermined number from the quiz storage unit 420, but provided on a user terminal, a quiz from the character storage unit 470, the submitter character data the submitter receives a trivia quiz and submit your character to the dialog provides a method to input answer data through the user terminal

In other words, as a trivia quiz includes questions like the submitter character quiz, the user can improve concentration by progressing in an interactive way to answer this.

In addition, the quiz data 30, Comment block diagram showing a spot information or comment for restaurants information on travel area of travel Area 31, quizzes blocks (32 representing the spot information or restaurants information on travel area of travel regions quiz), and it is processed into the form of a spot quiz module information or travel information of restaurants in the area traveling area including the image content block 33 representing a quiz video content data 30 may be stored.

Here, the data entered in each of the blocks 31, 32 and 33 may be each the pre-processing stored in the quiz storage unit 420, to create a single quiz data 30 in a manner filling it to the module have. Image content may be any of the image or video content the video image contents.

Therefore, in the fourth embodiment of the present invention, by making the quizzes description data, video content, modularize into question by processing and storage, the quiz maker can be manufactured easily.

### Fifth Embodiment

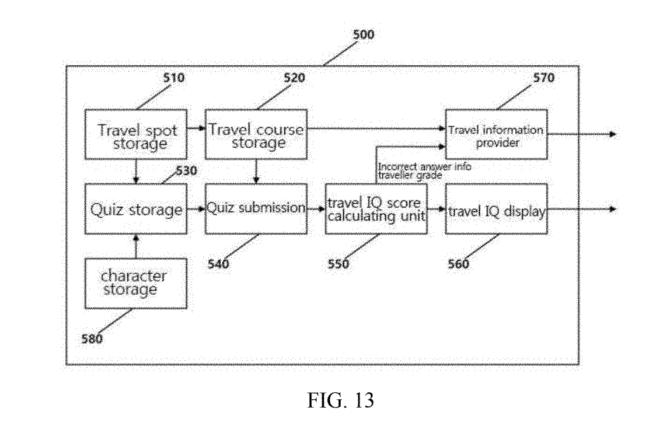

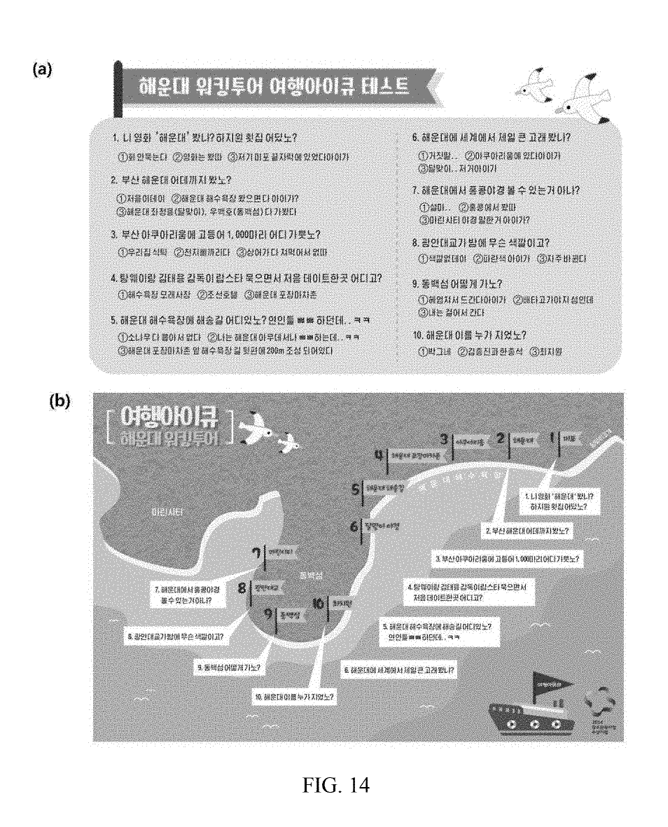

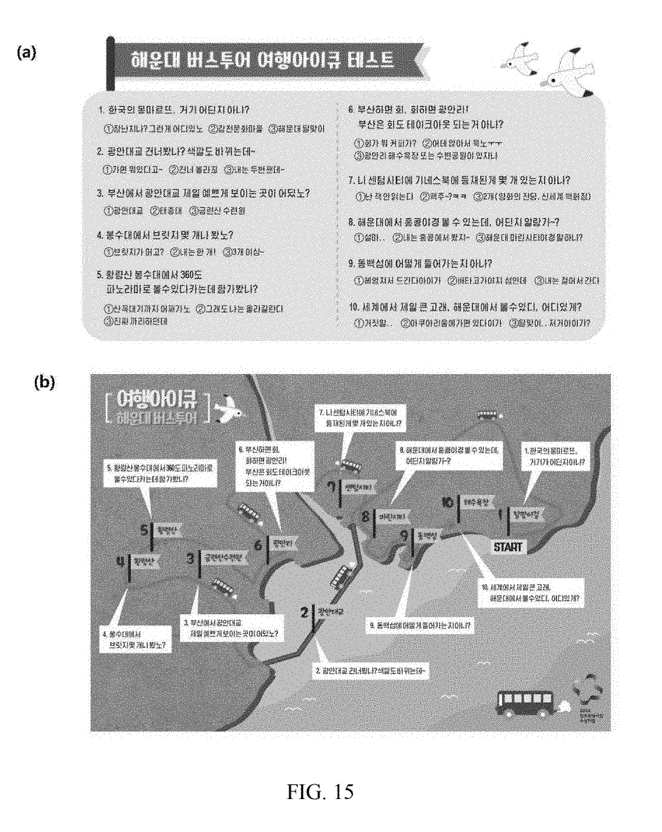

FIGS. 13 to 15 are diagrams for explaining a travel information providing apparatus according to the fifth embodiment of the present invention. Specifically, FIG. 13 is a fifth block diagram showing a travel information providing apparatus according to an embodiment of the present invention, FIG. 14 is a travel IQ test screen that is running in the quiz submission of operations according to a fifth embodiment of the present invention is shown the FIG. 15 is a diagram showing another screen of a travel IQ test running as quiz submission of operations according to the fifth embodiment of the present invention.

As shown in FIGS. 13 to 15, the travel information providing apparatus according to the fifth embodiment of the present invention, Where the storage unit 510, a travel course storage unit 520, a quiz storage unit 530, a quiz including the submission 540, travel IQ score calculation unit 550, a display travel IQ 560, travel information provider 570 and the character storage unit 580.

Travel course storage unit 520 is provided on the main server 500, and stores the data traveling course connecting the attractions or restaurants in the travel area. Specifically, further storing a plurality of data travel course, it is possible to store the separation of the travel course data based on the working stages, the type of travel tour bus or car rental tour, as shown in FIG. 15. In addition, it is possible to generate a data unlike the traveling courses in various kinds of travel, including private tours, transportation Tour.

Itinerary storage unit 520 stores a plurality of traveling there, but the course data can be stored by classifying the data according to the Travel Itinerary purpose of attractions or tours Restaurants tours. In other words, the travel can be provided with different kinds as well as the travel course depending on the purpose of travel. It is also possible to further refine stores divided by museums, historical sites, including the ruins tour, tour scenery spots and shopping attractions such as tour the sights.

Quiz 540 submission allows you to run a travel IQ test at the user terminal (20), and if a random quiz data for the attractions or restaurants located on the travel course of the tour course data from the quiz storage unit (530) extracting and, to the course from the starting point of the trip end points in order to provide the user terminal (20).

Here, quizzes, unit 540 may submit the quiz show simply submit a text-only screen. Itinerary storage unit 520 with a travel course data, save the travel area map data and trivia submitted 540 is by linking the quiz data in the map data, while moving along a travel course on a map quiz data it is possible to submit. By submitting quizzes travel along the course on the map, it is possible to further enhance the visual effect and exciting cause.

Thus, it can have effects of solving the quiz in advance for a virtual tour along the course and can solve problems for walking tours or bus tours so it can lead to a interesting tour. In other words, we can move as the major tourist destination with the travel IQ test conducted on the map and has the advantage that you can determine in advance where you want to travel for the journey.

On the other hand, the question is this, by the user to answer, with like quiz submitter 14 and 15, the only question is listed on the test screen, while inserting a quiz submitter character images move along the quiz submitter Itinerary traveling can get the recipient to give a talk effect.

### Sixth Embodiment

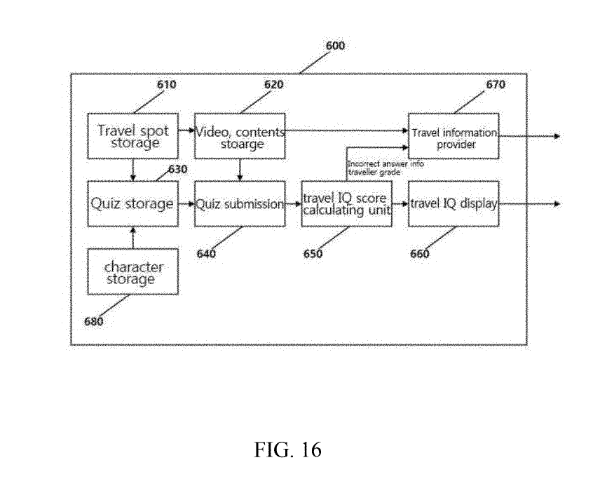

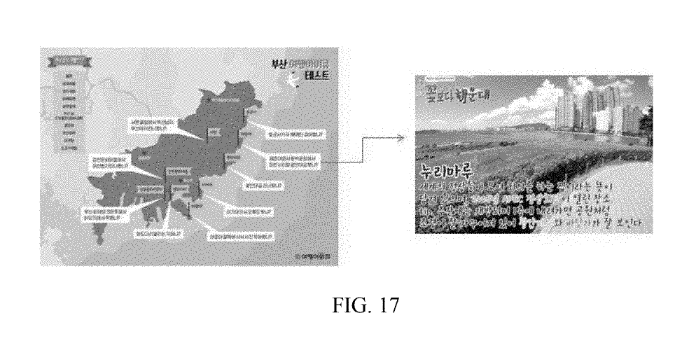

FIGS. 16 to 18 is a view for explaining a travel information providing apparatus according to a sixth embodiment of the present invention. Specifically, FIG. 16 is a block diagram showing a travel information providing apparatus according to a sixth embodiment of the present invention, FIG. 17 is a travel IQ test screen that is being executed in the operation portion quiz submitted according to a sixth embodiment of the present invention a diagram showing. 18 is a view showing for explaining another example of service travel information device according to a sixth embodiment of the present invention.

As shown in FIGS. 16 to 18, travel information providing apparatus according to a sixth embodiment of the present invention, Where the storage unit 610, the video content storage unit 620, a quiz storage unit 630, quizzes including the submission unit 640, travel IQ score calculation unit 650, the display travel IQ 660, providing travel information (670) and a character storage unit 680.

Video content storage unit 620 is provided on the main server 600, and stores the image data can be produced in conjunction with the quiz data. Here, the video content is to increase the understanding of the journey by providing a video tour conjunction with the IQ test questions, such as 17, can lead to interesting.

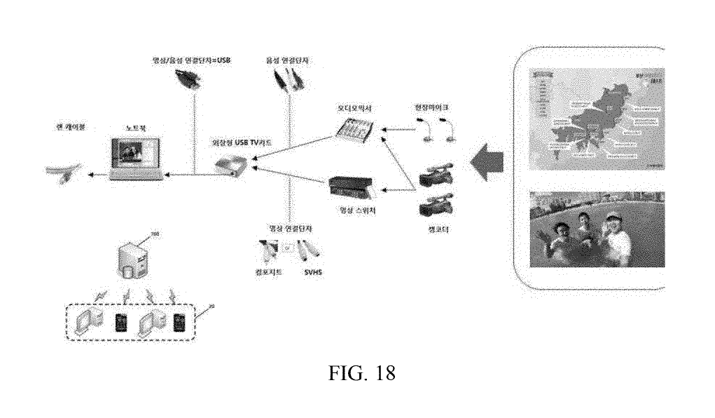

Further, referring to FIG. 18, through the user terminal to shoot an image of the restaurants which the location of one of the sights and the travel area of the travel area may include a user image content producer authoring as a user image content data.

In addition, travel information providing apparatus, is provided on the main server, the user is saved to receive content data, it is possible to include other user terminal and further a user image content stored shared in real time, or to provide the submitting quiz section. In this case, the user video content can be accomplished in a variety of content that is generated through scenic shots, taken from food restaurants, commented on the shooting, including shooting video with your travel IQ quiz in the form of spots.

Here, it is possible to store the real-time review the information that is input through the user picture contents storing unit, the user terminal or the another user terminal by the user associated with the video content data.

Thus, the sixth embodiment provides travel information according to the device of the present invention, more travelers and allows direct travel in conjunction with an IQ test in real time shared as raising the taken image at that point to the server, there is a video review share information and travel obvious can communicate.

### Other Embodiments

(A) The travel information providing apparatus according to another embodiment of the present invention is that by deleting the spot information data and restaurants information data in the travel region provided to the user terminal, or added to change the travel course display ingestion the course changing unit and changing travel courses to create a trip proposal course data, it is possible to include a proposal to transfer the itinerary parts store more data suggested.

Accordingly, the user can change the traveling course by deleting or adding the spot restaurants or optionally, it may be proposed on the main server in reverse. That is that it also creates a travel course of a specific user only. It is possible to accumulate the data according to the user's preferences changed to change the traveling course on the main server that stores a fluid.

(B) Presents another quiz storage unit quiz data in accordance with another embodiment save the language version of the dialect of the journey regional version and its travel regions, and quizzes to submit portions version dialect quiz data on your device or a foreign language version of the invention is possible to submit. For example, it is possible to improve the affinity to submit the quiz on the Busan dialect version if you travel to Busan region as shown in FIG. 5.

(C) Further, in another embodiment of the present invention is that you can know my ranking through the resulting distribution of travel IQ score, and may disclose travel IQ scores in such SNS Facebook, the Busan Further Seoul, Jeju race can be extended to the cities of Jeonju.

(D) In addition, in association with the position information of the traveling information providing unit the user terminal according to another embodiment of the invention, the spot information data on the travel course travel area by the user terminal corresponding to the place or places to move forward to the current position restaurants or the information data in the travel region can be provided in real time to the user terminal.

In addition, it is also possible to place in which the user terminal is located provides a real time review window on the user terminal, and collect real-time review the information that is input

Thus, travel information providing apparatus according to yet another embodiment of the present invention, it is possible to guide the smart function without the need for physical guide. In other words, using real-time GPS functionality, to see what provides the real-time personalized information according to the destination drawn as a travel IQ tests and quizzes, and what to eat can be implemented in conjunction smart tours are also custom discount tickets.

Furthermore, by utilizing GPS devices in real time reviews of users can also be created on trips and courses to be checked. That is, through the user terminal leaves a review, it is possible to review the data transmitted to the main server and displayed in real time on the travel course. Accordingly, and interest in the traveling course can promote more. It is possible to obtain more various and detailed information.

(E) Further, the travel information providing apparatus according to another embodiment of the present invention, it is possible to include the user information acquisition unit, traveling IQ test result collecting unit, a real-time review further collecting unit and trip big data storage.

Collecting user information unit, are placed on a main server, via the user terminal receives the user's age information, user gender, user revisit whether or at least one or more of the user of the vehicle or without information, collect user information do.

IQ travel are placed on a test result collecting unit, the main server, travel IQ collects test result information from the score calculating unit.

Collecting real-time review unit, it is placed on a main server, and collect real-time review information received from the user terminal in the course of the tour restaurants and attractions of the travel area.

Traveling big data storage unit, user information, travel IQ test results information and by linking real-time review information to be generated travel preferences information, travel marketing information or travel decision-making information, user information, travel IQ test results, information and real-time review information collects and stores data in the form of the big trip.

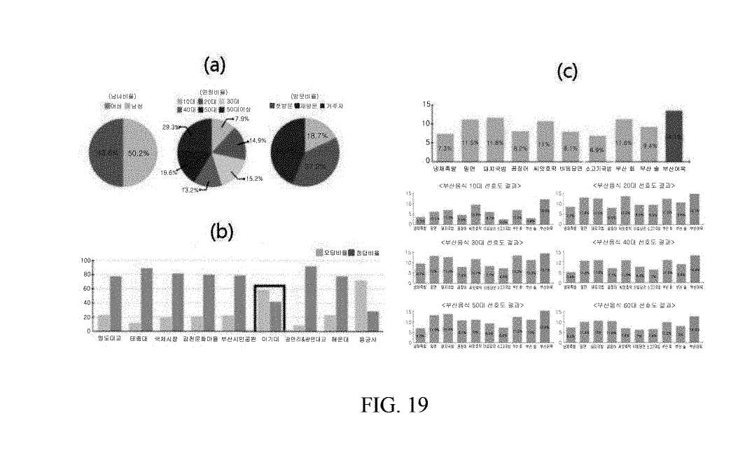

By such configuration, age, gender, revisiting whether the user information such as vehicle presence with, and performed Travel IQ test results, tourism preference utilizing data such as real-time review the actual tour, that tour poll It is possible. In other words, big data, and can be utilized as a tourist, you can also take advantage of the tourism policy-making and tourism marketing. In one example, FIG. 19 is a graph illustrating yet a preference information utilizing travel big data that is implemented by another embodiment provided in accordance with the travel information device of the present invention. Thus it can leverage big data to travel from municipalities, government offices or travel agents.

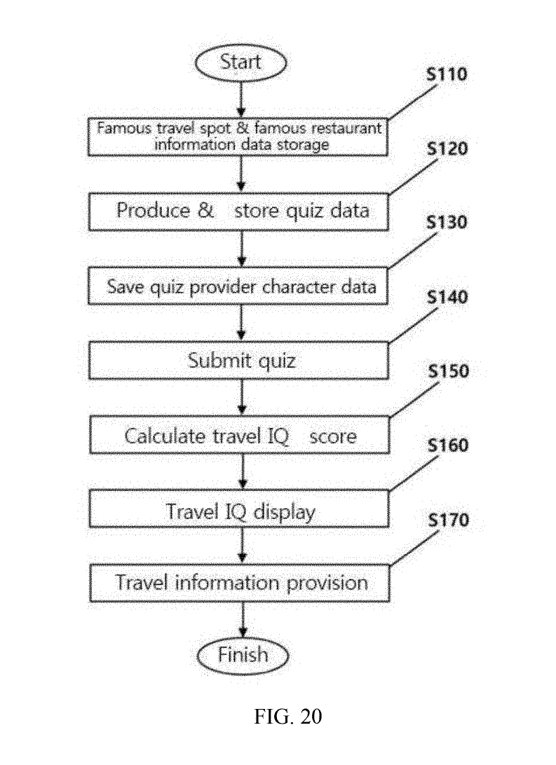

(F) FIG. 20 is a flowchart illustrating a travel information providing method according to an embodiment of the present invention.

As shown in FIG. 20, the travel information providing method according to an embodiment of the present invention, comprises the following steps:

First, a first step (S110), the information data stored in the sights and restaurants information data area of travel of the travel area on the main server.

Next, a second step (S120) by processing the information of the restaurants and attractions travel information area of the area of travel of the quiz form data stored on the main server.

Next, a third step (S130) in the storage is in order to submit the quiz data interactively, at least one quiz submitter character data on the main server.

Next, the fourth step (S140), the Running travel IQ test at the user terminal, extracts randomly quiz data of a predetermined number among the plurality of quiz data but provided on a user terminal, a quiz submitter character data from a character storage unit the submitter receives a trivia quiz and submit your character to the dialog provides a method to input answer data through the user terminal.

Next, in the fifth step (S150) by comparing the answer data to be input through the user terminal and the correct answer of the quiz data and calculates a score.

Next, a sixth step (S160) the display according to the rating traveler traveling IQ scores and travel IQ score calculated from the fifth step (S150) in the user terminal.

Next, a seventh step (S170), the information provided by selection and combination of data and spot information data of the Restaurants regional travel trip traveler ratings depending on local, personalized travel information to the user terminal.

Thus, the present embodiment the trip information providing device and travel information provision method using a travel IQ test in accordance with the invention, submit attractions and restaurants information on travel regions quiz form and inform your travel IQ score lead to giving travel interests can, and share a traveler ratings depending on travel IQ score can be simple by creating a personalized travel information beneficial to all travelers travel the region and provide efficient travel.

In addition, an embodiment of the trip information providing equipment and travel information provision method using a travel IQ test in accordance with the present invention, the local tourism industry activation and local economic development through the provision and sale of discounted tickets to free coupons indexed to travel you can contribute to.

Thus, the technical construction of the present invention described above it will be appreciated that can be embodied in that without changing the technical spirit or essential features of the other specific forms by those skilled in the art invention.

Thus, embodiments described above are to be understood as not that of will be illustrative in all respects only, and the scope of the present invention is represented by the claims below rather than the above detailed description, the appended claims the meaning and range and their equivalents and all such modifications that are derived from the type concept should be construed as being included in the scope of the invention.

What is claimed is:

1. An apparatus for providing travel information, comprising:
a storage unit for storing information, data and an attractions Restaurants travel information data area of a travel area provided on a main server;
a quiz storage unit for storing the processed information of the restaurants and a spot information of the travel area as the travel area quiz data provided on the main server;
a character storage unit for storing at least one quiz submitter character data to submit the data to the interactive quiz;
a plurality of the quiz for running the travel IQ test at the user terminal by randomly extracting the quiz data of a predetermined number among data from the quiz storage unit, but is provided on the user terminal, the quiz submitter character data from the character storage unit quiz character is received, the submitter to submit the quiz and the quiz section to submit offers to enter the answer to the interactive data via the user terminal;
a travel IQ score calculation unit for calculating a score by comparing the answer data which is input through the user terminal and the answer of the quiz data; and
a travel IQ display unit that displays a traveler ratings according to the travel IQ scores and the scores calculated by the calculating unit travel IQ scores on the user terminal.

2. The apparatus of claim 1, wherein:
The quiz data, local and description block diagram illustrating an attraction information or gourmet information of the travel area of the travel area with the comment, and quizzes block diagram illustrating an attraction information or gourmet information of the travel area of the travel area of the quiz, the travel of the spot information or travel information providing apparatus characterized in that the store is processed in the form of a quiz module including an image representing the content block information of the restaurants travel area as the picture content.

3. The apparatus of claim 1, further comprising a travel course to connect the data stored in the course of travel attractions or restaurants in the area and save the travel area travel map data provided on the main server; and
among the quiz submitted blowing a plurality of the quiz data by extracting the quiz data corresponding to the spots or restaurants located on a traveling course of the travel course data from the quiz storage unit, by connection to the map data, the traveling course on the map while moving in sequence from the starting point to the end points along the travel information providing apparatus, characterized in that to submit the quiz data.

4. The apparatus of claim 3, further comprising:
storing a plurality of traveling course data storage unit includes a traveling course but, depending on the type of trip walking tours, bus tours or rental car tour Itinerary storage by separating the data,
the trip includes travel offer courses in the storage unit wherein storing data by dividing the traveling course according to the purpose of the trip, but stores a plurality of course data travel, attractions or tours Restaurants tours.

5. The apparatus of claim 1,
depending on the grade selected tourist spot information, the combination of the data and the information data of the restaurants travel area of the travel area, and further includes a travel information service providing personalized travel information on the user terminal, and
above travel spot storage is stored in the travel preference information according to the traveler's grade in each of the restaurants information data attractions and tour areas of the travel areas, and provide the travel portion sights of the tour areas by using the travel preference information data information and apparatus characterized in that the selection and combination of restaurants information data of the travel area.

6. The apparatus of claim 5, wherein
a travel course changing unit to the user terminal from the travel information provided to the adding or deleting data and spot information restaurants information data of the travel area of the traveling regions where the traveling course by changing;
produced by the ingestion itinerary changes are proposed to the traveling course data, and proposed an itinerary unit that transmits the data suggest the itinerary parts store;
the main are placed on a server, via the user terminal receives the user's age information, user gender, user revisit whether or at least one or more of the user of the vehicle whether or not the information, user information that collects user information collection unit;
the above is provided on the main server, travel IQ test result collecting unit which collects travel IQ test result information from the travel IQ score calculation unit;
the above is provided on the main server, a real-time review the collecting part that collects real-time review the information entered through the user terminal in the course of the tour restaurants and attractions of the traveling area of said travel area; and
the user information, the travel IQ test result information and the user information, the travel IQ test results information and the real-time review information to allow generating the real-time review by linking information to travel preferences information, travel marketing information or travel decision-making information collecting trip to Big data storage unit for storing data in the form of a big trip.

7. The apparatus of claim 1,
a video content storage unit for storing the image data produced by the content associated with the quiz data provided on the main server;
a user image by photographing a user terminal through the image of any one of the position of the spots and restaurants in the area of traveling the travel area as the user authoring the content data, video content producer; and
a user image content storage unit which stores the user image received by the contents data, and shared with the other user terminals with real-time, or provided to the quiz submitted unit is provided on the main server;
wherein,
the user image content storage unit, the user terminal or the other provides travel information to the real-time review the information that is input through the user terminal characterized in that the store associated with the user to the video content data device.

8. A method for providing travel information, comprising following steps:
a first step includes storing information data of the spot information data and restaurants travel area of the travel area on the main server;
a second step of the spot information by processing information of the restaurants and the travel area of the travel area as the data storage form of the quiz on the main server;
a third step of storing in the at least one quiz submitter the character data main server to submit the data to the interactive quiz;
a fourth step of the character file a quiz and provided by the dialog method to input answer data through the user terminal, running the travel IQ test at the user terminal, but is provided on the user terminal to extract randomly the quiz data of a predetermined number among the plurality of the quiz data, receiving the quiz submitter character data from the character storage unit quiz submitter;
a fifth step of calculating a score by comparing the answer data which is input through the user terminal and the answer of the quiz data;
a sixth step for displaying the rating based on a traveler traveling IQ scores and the travel IQ score calculated from the fifth step on the user terminal; and
a seventh step of, depending on the grade selected, the combination of the tourist spot information data and restaurants information data of the travel area of the travel service area, the customized information traveling on the user terminal.
